(19) United States
(12) Patent Application Publication
(10) Pub. No.: US 2014/0043610 A1
(43) Pub. Date: Feb. 13, 2014

(54) APPARATUS FOR INSPECTING A MEASUREMENT OBJECT WITH TRIANGULATION SENSOR

(71) Applicant: Carl Zeiss Industrielle Messtechnik GmbH, OBERKOCHEN (DE)

(72) Inventors: Thomas ENGEL, AALEN (DE); Peter WESTPHAL, JENA (DE)

(73) Assignee: Carl Zeiss Industrielle Messtechnik GmbH, OBERKOCHEN (DE)

(21) Appl. No.: 13/961,579

(22) Filed: Aug. 7, 2013

Related U.S. Application Data
(63) Continuation of application No. PCT/EP2012/065474, filed on Aug. 7, 2012.
(60) Provisional application No. 61/680,407, filed on Aug. 7, 2012.

(51) Int. Cl. G01B 11/14

(52) U.S. Cl. CPC G01B 11/14
USPC 356/369; 356/623

(57) ABSTRACT

An apparatus for inspecting a measurement object, comprising a workpiece support for receiving the measurement object and a measuring head carrying an optical sensor. The measuring head and workpiece support are movable relative to one another. The optical sensor has an objective and a camera for capturing an image of the measurement object. The objective has a light entrance opening and a light exit opening, a diaphragm, and a multitude of lens-element groups arranged in the objective between the light entrance opening and the light exit opening one behind another along a longitudinal axis of the objective. At least two lens-element groups are displaceable parallel to the longitudinal axis. An illumination device illuminates the measurement object at a triangulation angle relative to the longitudinal axis, and a sensor device detects radiation from the illumination device that is incident on the sensor device through the objective.

### CROSS-REFERENCE TO RELATED APPLICATIONS

This application is a continuation of International PCT application No. PCT/EP2012/065474, filed Aug. 7, 2012. This application also claims the priority of U.S. provisional application No. 61/680,407, filed Aug. 7, 2012. The entire contents of these priority applications are incorporated herein by reference.

### BACKGROUND OF THE INVENTION

The present invention relates to an apparatus for inspecting a measurement object, comprising a workpiece support for receiving the measurement object, comprising a measuring head carrying an optical sensor, wherein the measuring head and the workpiece support are movable relative to one another, wherein the optical sensor has an objective wherein the objective has a light entrance opening and a light exit opening, wherein the objective furthermore has a diaphragm and a multitude of lens-element groups which are arranged in the objective between the light entrance opening and the light exit opening one behind another along a longitudinal axis of the objective, and wherein at least two lens-element groups are displaceable parallel to the longitudinal axis.

The use of optical sensors in conjunction with coordinate measuring machines makes it possible in many cases to measure geometrical properties of a measurement object very rapidly. One disadvantage of known coordinate measuring machines comprising optical sensors heretofore has been that the optical sensors are limited to specific measurement tasks and specific workpiece properties. The optical sensors are generally optimized for a specific type of measurement task, for instance with regard to the achievable measurement accuracy or the measurement range. Problems can be posed for example by workpieces which have large height differences parallel to the optical axis of the sensor. In part, different optical and/or tactile sensors are used in order to be able to react flexibly to different measurement requirements, wherein the individual sensors in each case perform only part of the overall measurement task. In general, each individual sensor is optimized toward a specific measurement task. Primarily optical sensors therefore have a respective individual optics which is well suited to a specific purpose of use and is less well suited to other purposes.

The provision of different sensors for different measurement tasks in a coordinate measuring machine makes possible a high flexibility in conjunction with a high measurement accuracy. The high costs for the provision of the numerous sensors with in each case a dedicated optics adapted to the purpose of use of the sensor are disadvantageous. Furthermore, the large number of sensors with in each case a dedicated optics require a relatively large structural space in the coordinate measuring machine, which restricts the measurement volume and causes further costs.

Triangulation methods for determining the coordinates of a specific point of a measurement object are already known in optical metrology. From a known position and orientation of a light source that irradiates the measurement object, and from a known position of a sensor device, the topography of the measurement object can be determined from detected variables such as the impingement location of the intensity distribution of the radiation reflected by the measurement object, using trigonometrical relationships.

Examples of triangulation methods are mentioned in the document DE 10 2010 007 396 A1, for instance. An apparatus for inspecting an object is known from the document DE 103 40 803 A1, for example.

Triangulation methods using lasers as light sources use either a point focus or a line focus that is moved over a surface to be measured of a measurement object. In this case, a line focus is usually formed from collimated beams having a one-dimensional or areal structure which have an only weakly pronounced beam waist in the or near a measurement region. The apparatuses which implement such triangulation methods have a constant triangulation angle and an imaging optics designed with regard thereto. The available measurement volume is therefore fixed and not variable.

There is therefore a desire to provide an optical coordinate measuring machine which can perform a large range of optical measurement tasks in conjunction with comparatively low costs. Accordingly, it is an object of the present invention to specify a corresponding apparatus.

### SUMMARY OF THE INVENTION

According to one aspect of the invention, it is therefore provided an apparatus for inspecting a measurement object, comprising a workpiece support for receiving the measurement object, comprising a measuring head carrying an optical sensor, wherein the measuring head and the workpiece support are movable relative to one another, wherein the optical sensor has an objective, wherein the objective has a light entrance opening and a light exit opening, wherein the objective furthermore has a diaphragm and a multitude of lens-element groups which are arranged in the objective between the light entrance opening and the light exit opening one behind another along a longitudinal axis of the objective, and wherein at least two lens-element groups are displaceable parallel to the longitudinal axis, wherein the apparatus furthermore has an illumination device for at least partly illuminating the measurement object at at least one triangulation angle relative to the longitudinal axis, wherein the apparatus furthermore has a sensor device for detecting radiation from the illumination device that is incident on the sensor device through the objective and wherein the sensor device can be arranged in an inclined manner relative to the incident radiation.

According to a further aspect of the invention, it is therefore provided a coordinate measuring machine comprising an apparatus for inspecting a measurement object, comprising a workpiece support for receiving the measurement object, comprising a measuring head carrying an optical sensor, wherein the measuring head and the workpiece support are movable relative to one another, wherein the optical sensor has an objective, wherein the objective has a light entrance opening and a light exit opening, wherein the objective furthermore has a diaphragm and a multitude of lens-element groups which are arranged in the objective between the light entrance opening and the light exit opening one behind another along a longitudinal axis of the objective, and wherein at least two lens-element groups are displaceable parallel to the longitudinal axis, wherein the apparatus furthermore has an illumination device for at least partly illuminating the measurement object at at least one triangulation angle relative to the longitudinal axis, wherein the apparatus furthermore has a sensor device for detecting radiation from the illumination device that is incident on the sensor device through the objective and wherein the sensor device can be arranged in an inclined manner relative to the incident radiation, and wherein the longitudinal axis forms a Z-axis of a Cartesian coordinate system, and wherein the measuring head and the workpiece support are movable relative to one another parallel to an X-axis and to a Y-axis, wherein the X-axis and the Y-axis are perpendicular to one another and span an X-Y plane to which the Z-axis forms a normal, and wherein the sensor device is arranged in such a way that a normal to a sensor plane of the sensor device runs in a central plane that forms an angle of 45° both with the X-axis and with the Y-axis.

A sensor device is thus provided which is designed for carrying out a triangulation method for inspecting the measurement object. Furthermore, the radiation incident on the sensor device is likewise imaged through the objective. The sensor device can be arranged “in an inclined manner” relative to the incident radiation. This means that the sensor device, in particular a sensor plane of the sensor device, can be arranged in an orientation that is not transverse or perpendicular with respect to the incident radiation. In the context of the present application, “in an inclined manner” means that the sensor device, in particular a sensor plane of the sensor device, is arranged at an angle of less than 90° relative to the incident radiation. In this case, “can be arranged” should be understood to mean that the sensor device can be arranged in an inclined manner with respect to the incident radiation in a stationary fashion or else—as will be explained below—can be arranged in a pivotable manner relative to the incident radiation. The pivotability can then enable for example an arrangement perpendicular to the incident radiation or at an angle of less than 90° relative to the incident radiation.

By virtue of the fact that the objective, or in other terms lens or lens assembly, has variable actuators or at least two displaceable lens-element groups, variation possibilities arise with regard to imaging scale or magnification, nominal operating distance, numerical aperture during imaging, telecentricity both on the image side and on the object side, and the possibility, by fitting so-called chromatic assemblies, of introducing imaging aberrations such as, for example, longitudinal chromatic or transverse chromatic aberrations in a targeted manner and thereby improving the triangulation method. In particular, in this way it becomes possible to operate at a plurality of operating distances and selectively also with different triangulation angles, wherein the possibility of varying the imaging scale and the possibility of telecentricity both on the image side and on the object side enable the best possible utilization of the sensor device.

In a further refinement of the apparatus it can be provided that the apparatus furthermore has a tilting device coupled to the sensor device and serving for tilting the sensor device relative to the incident radiation.

In this way it is possible, for example, in the case of a sensor device having a two-dimensional sensor array, to incline as desired the sensor plane formed by the two-dimensional sensor array relative to the beam of rays incident on the sensor device or relative to the optical axis of the lens-element groups of the objective. As will also be explained below with reference to FIG. 8, a sharp imaging on the entire sensor device can be provided in this way. Since a laser line or a laser beam of the illumination device is incident in an inclined manner with respect to the optical axis of the objective, the sensor device has to be appropriately inclined for the respective inclination of the laser beam. This inclination is substantially dependent on the magnification of the optical system or of the objective, since the inclination angle of the radiation impinging on the measurement object is thereby also imaged differently. If it were desired to operate the apparatus in such a way that the triangulation angle is kept constant and a different magnification of the objective is employed, then the sensor device must be inclined in a manner corresponding to the magnification. This will make it possible to operate with a constant triangulation angle with different magnifications in conjunction with sharp imaging over the entire sensor plane. In principle, it can be provided that the sensor device can also be inclined into a position perpendicular relative to the incident radiation, in order to provide a possibility for normal image capture in other measuring methods.

The coupling of the properties of the objective, in particular the variable imaging scale or the changeable magnification of the zoom objective with the variable triangulation angle, makes the resolution of the measuring system adjustable. In the case of a specific inclination of the sensor device, with a nominal operating distance it is possible to set the necessary triangulation angle by means of the magnification, which triangulation angle then has to be selected or set.

In a further refinement of the invention it can be provided that the illumination device is designed in such a way that different triangulation angles are selectable.

In this case, the illumination device can either be designed in such a way that the triangulation angle at which a specific illumination device irradiates the measurement object can be varied. However, provision can also be made for providing a plurality of illumination devices which irradiate the measurement object in each case at a different triangulation angle, and wherein selectively one or a plurality of these illumination devices can be switched.

From the combination of the adjustability of magnification or imaging scale of the objective and/or the inclination of the sensor device and/or the triangulation angle of the illumination device, the apparatus affords the possibility of appropriately setting the operating range (depth resolution range) and/or the resolution of image capture for a specific operating distance. The two variables proceed oppositely with regard to the magnification or the aperture, and so it is possible to select between an overview image with moderate resolution and large depth of the operating range and a detail image with high resolution and in return smaller depth of the operating range.

For the illumination system this gives rise to the degrees of freedom that different triangulation angles can be set for a single operating distance.

In the context of the present invention, an “operating distance” can be understood to mean here either a mechanical operating distance, that is to say the distance between the measurement object and the first disturbing contour of the apparatus, for example the entrance plane into the objective or the mount of a first lens-element group, or else an optical operating distance, that is to say a distance between the optical element of the objective that is situated furthest on the object side and the focal plane of the objective or the imaging optics. Furthermore, in this way different triangulation angles can also be set for different operating distances. This makes it possible, in particular, to influence the depth of field or depth resolution or the quality of the imaging of a beam profile of the illumination device. Said depth of field also influences the robustness of the measuring system since, for a precise measurement, the object topography should be situated within the depth of field range or the operating range of the apparatus. A larger operating range thus allows larger height differences in the object topography. Through the free choice of the triangulation angle and/or of the magnification or imaging scale of the objective and/or the tilting of the camera, said depth of field is provided as a parameter for a user of the apparatus.

In a further refinement of the apparatus it can be provided that a direction of incidence of the radiation from the illumination device on the measurement object, a normal to a sensor plane of the sensor device and an optical axis of the objective lie in one plane.

A “direction of incidence” is understood to mean a direction of propagation of the radiation from the illumination device. The direction of incidence together with the triangulation angle determines the direction of propagation of the radiation from the illumination device onto the measurement object. In the case of a collimated beam of rays, the entire beam of rays has the same direction of incidence. However, the illumination device can also emit a beam fan. In this case, the direction of incidence is an angular range. At least one direction of incidence of the beam fan is then intended to intersect the optical axis, such that the abovementioned condition is fulfilled. In particular, the direction of incidence of a central ray or of the angle bisector of the angular range of the beam fan is intended to intersect the optical axis.

For the resolution and functionality of the arrangement of the triangulation sensor it is advantageous if the irradiating direction of the illumination device, the optical axis of the imaging system and the surface normal of the sensor device all lie in one plane. Deviations from this condition lead to more complicated geometries that require additional outlay in order to correct the resultant aberrations optically or by additional computational complexity.

In one refinement of the invention it can furthermore be provided that the illumination device is designed in such a way that it is possible to choose the direction of incidence of the radiation from the illumination device about a pivoting axis, running parallel to the longitudinal direction or longitudinal axis, in steps or in a continuously variable manner.

In this way it becomes possible to choose the irradiating device as desired and depending on the object topography in such a way that a particularly advantageous measurement of the measurement object is possible.

In a further refinement of the invention it can be provided that the sensor device is pivotable about a pivoting axis running parallel to the longitudinal direction or longitudinal axis.

A corresponding pivoting device for pivoting the sensor device can thus be provided. In this way it becomes possible to align the surface normal to a sensor plane of the sensor device such that it lies in one plane together with the irradiating direction of the illumination device. In particular, the pivoting axis can be the optical axis of the objective. In this way it is always ensured that the optical axis and the surface normal to the sensor plane of the sensor device lie in one plane. In principle, however, it is also possible for the pivoting axis and the optical axis to diverge. In this case, a carrier system for the sensor device can additionally be provided, which enables a translational movement of the sensor device in such a way that the surface normal and the optical axis can again be brought into one plane.

In a further refinement of the invention it can be provided that the illumination device has a plurality of illumination assemblies. Each individual illumination assembly can be designed for projecting a line or a point focus onto the measurement object.

In this way provision can be made, for example, for arranging different illumination assemblies with different triangulation angles and/or different irradiating directions about the optical axis of the objective. In this way, triangulation angle and irradiating direction can be chosen by corresponding switching of the respective illumination assembly.

In a further refinement of the invention it can be provided that the illumination device is pivotable about a pivoting axis running parallel to the longitudinal direction or longitudinal axis.

In this case, it can also be provided that a single or a plurality of the illumination assemblies of the illumination device is or are pivotable about a pivoting axis running parallel to the longitudinal direction. In particular, the pivoting axis can be the optical axis of the objective.

Consequently, the apparatus can be embodied in such a way that the illumination can be effected at the triangulation angle from different directions. In this case, either a plurality of illumination assemblies can be provided, and one illumination assembly can be rotated about a pivoting axis, or it can also be provided that the illumination device or one of the illumination assemblies has optical elements for deflecting a radiation of the illumination device or illumination assemblies in different directions. In this case it can be provided that a pivoting of the sensor device is effected in a coupled manner in such a way that optical axes, surface normal of the sensor device and irradiating direction always lie in one plane.

In a further refinement of the invention it can be provided that for setting the triangulation angle and/or the direction of incidence of the radiation, at least one microscanner is arranged for deflecting the radiation.

Such microscanners are so-called micro-optoelectromechanical systems (MEMS scanner) or a so-called “digital micromirror device” (DMD). This involves micromirror actuators that can be moved rotationally about one or two axes. A deflection of a light wave incident on the mirror element can be obtained in this way. By means of these elements, a beam deflection can be brought about in a targeted manner even when there is only little structural space available, and with the necessary actuating accuracy. Alternatively, it can also be provided that a tilting or pivoting of the illumination device itself can be effected in order to set the triangulation angle and/or the direction of incidence of the radiation.

In a further refinement of the apparatus it can be provided that the illumination device projects the radiation onto the measurement object in a punctiform manner, or that the illumination device projects the radiation onto the measurement object in a linear manner by means of an illumination imaging optics.

In this case, it is possible either to provide illumination devices that generate a constant line over the entire width of the field of view of the sensor device. Alternatively, however, it is also possible to provide illumination device that project points onto the measurement object, which are then moved over the object for example by MEMS scanners. In particular, it is also possible to provide illumination devices in which the intensity of the incident light is readjusted such that the measurement signal recorded by the sensor device has a minimum intensity. A signal-to-noise ratio suitable for a precision measurement can be produced in this way.

If a line is intended to be projected onto the measurement object, it is possible to implement a beam reshaping by means of various optical components for desired beam profile generation.

In particular, it is possible to use in varying order and combination for example anamorphic prisms for symmetrizing the beam profile, cylindrical optics for symmetrizing the beam profile, spherical and aspherical round optics for beam conditioning and beam expansion, diffractive optical elements, computer generated holograms (CGH), holographic optical elements and/or telescopes or imaging optics with combinations of spherical and cylindrical lens elements for line projection. So-called “graded index lens elements (GRIN)” for a compact optical construction are also possible for correction and beam reshaping. The GRIN lens elements can also be used in combination with a diffractive optical element, which are arranged on a surface of the GRIN lens element.

With diffractive optical elements, a group of a plurality of lines can also be generated simultaneously. This property can be utilized in particular in connection with the variable magnification scale that is possible through the objective, since each of said lines can be arranged in a zone of sharpness of the sensor device such that they do not mutually disturb one another during a measurement. In this case, it can also be provided that said plurality of lines are caused to overlap in an operating region of the sensor by means of a further imaging optics. Lines having incorrect inclination are then detected only in the image center or in a narrow region of the image and are imaged only unsharply or as background light in the case of topographies of the measurement object having a relatively large height difference. In this way, the lines can then ultimately be differentiated during the evaluation or in the image by means of a slight change of the focus setting parallel to the optical axis of the objective. Lines having incorrect inclination then disappear, and only the structure having appropriate inclination and a corresponding triangulation angle is imaged sharply. Alternatively, it is also possible to provide the lines with a pronounced structure that makes them distinguishable during the measurement. By way of example, for this purpose an intensity profile of the line can be set correspondingly differently. By way of example, in the case of three lines, one line can have a Gaussian profile or a Gaussian normal distribution with regard to the light intensity, one line can have a triangular profile and a third line can have a rectangular profile. In the case of such an overlap, it is then also automatically evident from the intensity distribution that more than one intensity profile is involved in the current measurement. This is the case when the intensity rises abruptly over the measuring line. This rise then simultaneously identifies the center of the measurement region.

In a further refinement of the invention it can be provided that the illumination device has at least one light source, wherein the light source is a laser or a light emitting diode (LED).

By means of these light sources, in the case of a laser it is possible to provide a coherent light source having a specific wavelength, and in the case of an LED it is possible to provide a non-coherent light source in a specific, relatively narrow wavelength range.

For illumination with lines or patterns, it is possible to use LEDs having high luminance together with a beam reshaping imaging optics and/or a transmission mask. In this regard, a certain proportion of light is lost with the use of LEDs, but the beam intensity of an LED can already suffice for many applications. Furthermore, LEDs are generally more cost-effective than the use of lasers as light source.

In a further refinement it can be provided that the radiation which at least partly illuminates the measurement object is polarized.

A further degree of freedom for the measurement consists in the use of a polarization. This effect is of particular importance in particular in the case of transparent or partly transparent measurement objects, since the reflection at a front surface and also at a rear surface of the measurement object is dependent on the polarization. However, a reflection at a rear side of the measurement object is visible only when the optically active thickness of the component lies within the operating range or the depth of field range of the sensor device. In the case of non-transparent measurement objects, such a differentiation does not occur anyway, since the light can only be reflected or scattered by the initially irradiated surface and is otherwise absorbed. A further effect dependent on a polarization consists in the interaction of incident light with a possible texture of the irradiated surface of the measurement object. If the surface is structured for example by machining traces of turning or milling machining or matted by brushing or sand blasting then the magnitude of a signal detected by means of the sensor device is also dependent on the polarization of the light incident on the measurement object. In the case of transparent objects, a polarization direction perpendicular to the plane of incidence of the light is advantageous if the largest possible portion of the incident light is intended to be reflected at the surface. In the case of structured objects, a polarization direction parallel to the structure direction is advantageous.

In this case, in one refinement it can be provided that the light emitted by the light source of the illumination device is polarized, or that the illumination device has a polarization element.

By way of example, it is possible to use a laser that emits polarized light. Furthermore, a polarizer can be inserted into the beam path on the beam route between the light source and the measurement object.

In one refinement of this apparatus it can be provided that the illumination device has a λ/2 element for aligning the polarization direction.

Alternatively, it is also possible, of course, to provide two λ/4 elements. In particular, it can be provided that a rotatable λ/2 element is provided. In particular, an axis of rotation of the λ/2 element can lie parallel to a direction of incidence of the light incident on the λ/2 element. In this way, the polarization of the light from the illumination device can be set appropriately according to position and texture of the measurement object.

In a further refinement of the apparatus it can be provided that the illumination device has a plurality of light sources, wherein the light sources emit light in different wavelength ranges or with different wavelengths.

In this way it becomes possible to carry out both progressively and simultaneously a triangulation measurement with different wavelengths or in different wavelength ranges. This is advantageous particularly when a measurement object consisting of a plurality of different regions is intended to be measured. Particularly transitions between different materials can thus be detected particularly well. Moreover, it can thus be possible, using the chromatic aberration, to improve the accuracy or resolution of the system.

In this case, the wavelengths or wavelength ranges can be in the range of the visible spectrum between 380 nm and 780 nm. In particular, it can be provided that at least one of the light sources emits light in the near infrared range between approximately 750 nm and approximately 790 nm. Light in the infrared range or in the ultraviolet range can also be used. Consequently, the light used can also have a wavelength of approximately 300 to approximately 380 nm or of approximately 780 to approximately 1100 nm.

In one refinement of the apparatus it can be provided that each light source is an LED or a laser, and wherein the illumination device has an optical fiber and a pivotable reflection element arranged in such a way that selective coupling of the light emitted by one of the light sources into the optical fiber is made possible by pivoting of the reflection element.

In particular, the reflection element can be an MEMS scanner.

In a further refinement of the apparatus it can be provided that the apparatus furthermore has an autofocus illumination device for projecting a line grating onto the measurement object and a camera, which is designed to capture an image of the measurement object through the objective, and wherein a line grating reflected by the measurement object is evaluated by means of the sensor device.

In particular, in this case the autofocus illumination device is arranged in such a way that the line grating is projected onto the measurement object through the objective.

In this case, the possible multiple use of the sensor device is of particular interest. Consequently, the sensor device can be used not only for carrying out a triangulation measuring method but also for an autofocusing function by means of a line grating. The normal image detection is then effected by means of the camera. In the case of such an autofocusing sensor, preferably the sensor plane of the sensor device is inclined rather than an object plane with the laser grating, since the structures of the measurement object then have the least disturbing effect on the process of finding the focusing position. In principle, however, both the laser grating and the sensor plane of the sensor device can be inclined. However, it is also possible for only either the laser grating or the sensor device to be inclined. In combination with the triangulation method proposed here, it is possible to provide either only a tilted sensor plane of the sensor device or a tilting of both the sensor plane of the sensor device and the laser grating on the measurement object. Preference is given, in particular, to the variant in which the sensor plane of the sensor device is inclined. In this case, however, the projected laser grating is not inclined.

In one refinement it can be provided here, in particular, that the apparatus furthermore has an autofocus beam splitter for separating a beam path of the autofocus illumination device and a beam path to the sensor device, and that the apparatus furthermore has a coupling-in beam splitter for coupling in the beam path of the autofocus illumination device and the beam path to the sensor device to the longitudinal axis.

In this way, the use of the sensor device both for the triangulation measuring method and for the autofocus setting can be implemented structurally.

In one refinement it can be provided that provision is furthermore made of an autofocus tilting device for tilting an emission plane of the autofocus illumination device in the apparatus.

As has been explained above, it can also be provided that both the autofocus illumination device and the sensor device can be tilted for carrying out an autofocusing. In this way, a more sensitive setting of the boundary conditions of the autofocusing can be made possible in which, in particular, the surface properties of the measurement object can be taken into account by the variable position of the line grating.

In one refinement of the apparatus it can be provided that the sensor device has a two-dimensional sensor array, and wherein the sensor device is, in particular, an HDR (High Dynamic Range) camera, in particular a lin-log CMOS camera.

An HDR (High Dynamic Range) camera has a dynamic range of more than 50 dB, in particular more than 100 dB. In particular, a planar detector such as, for example, a camera with CCD, CMOS sensors will therefore be used. Said sensors can use a linear, logarithmic characteristic curve or a lin-log characteristic curve. In the case of a point projected onto the measurement object, it can also suffice for the sensor device to have only a linear detector or a one-dimensional sensor array.

In this case, sensor devices having a high dynamic range, such as lin-log CMOS cameras, for instance, are advantageous since, by this means, the position of the light beam from the illumination device, said light beam being radiated through the measurement object on the measurement object becomes measurable and it also becomes possible to determine the surface of the measurement object in the illumination environment, since it is not swamped by the illumination. A relatively high dynamic range is also advantageous, in particular, when a plurality of illumination assemblies or a plurality of lines are employed which cross for example in the image center of the image that is imaged onto the sensor device from the object.

In one refinement of the apparatus it can be provided that the apparatus is provided in a coordinate measuring machine, and wherein the longitudinal direction or longitudinal axis forms a Z-axis of a Cartesian coordinate system, and wherein the measuring head and the workpiece support are movable relative to one another parallel to an X-axis and to a Y-axis, wherein the X-axis and the Y-axis are perpendicular to one another and span an X-Y plane to which the Z-axis forms a normal, and wherein the sensor device is arranged in such a way that a normal to a sensor plane of the sensor device runs in a central plane that forms an angle of 45° both with the X-axis and with the Y-axis.

Typically, in use the measurement objects are oriented with their axes parallel to the axes of a carrier system. For a simple system it is therefore advantageous if a direction of incidence of the illumination device runs on the angle bisector between the X-axis and the Y-axis of the carrier system. In such an arrangement it is possible to measure structures which are oriented along the principal axes of the workpiece. Although to some extent relative to a maximum achievable resolution present precisely in the direction of the irradiating direction at the triangulation angle, the resolution is reduced in each case by approximately 40%, in return this resolution is present both in the X-direction and in the Y-direction and thus along the principal axes of the workpiece.

If, in one refinement, it is provided that the sensor device has a fixed inclination relative to the radiation incident on it, the illumination device or the illumination assemblies are accordingly designed in such a way that different triangulation angles can be selected. Different appropriate operating distances and/or magnifications can also be set for them by means of the objective. It goes without saying, however, that it is furthermore also possible that the sensor device can be set in a pivotable manner and the triangulation angles can also be chosen differently.

In a further refinement of the apparatus it can be provided that the apparatus has a controlling device that controls an inclination of the sensor device relative to the incident radiation, a triangulation angle and an imaging scale of the objective. In particular, this can be chosen on the basis of user inputs with respect to an operating distance and/or a depth of an operating range of the apparatus and/or a resolution of the image capture of the sensor device.

In this way it becomes possible for the first time that a user can select, for a specific operating distance, whether said user would like to create an overview image or a detail view, for example. From the combination of the adjustability of magnification or imaging scale of the objective and/or the inclination of the sensor device and/or the triangulation angle of the illumination device, the apparatus provides the possibility of setting, for a specific operating distance, the operating range (depth resolution range) and/or the resolution of image capture. This can be done automatically by means of the controlling device. For this purpose, by way of example, tables having the settings appropriate for specific user inputs can be stored in said controlling device.

In a further refinement of the illumination device it can be provided that the illumination device projects a point focus onto the measurement object, wherein the point focus can be moved relative to the measurement object. This can be implemented either by a movement of the carrier system or by a corresponding pivotable optics of the illumination device. In this case, the movement of the point focus need not necessarily be linear. Movements in curves or arbitrary other paths are also conceivable.

Furthermore, it is also possible for the illumination device or an illumination assembly to have a beam reshaping optics, which projects a line focus, which does not only run in one direction or linearly. A curved line or a curve can also be involved.

In a further refinement it can be provided that a first lens-element group from the at least four lens-element groups is arranged in a stationary fashion in the region of the light entrance opening, and that the diaphragm and a second lens-element group, a third lens-element group and a fourth lens-element group from the at least four lens-element groups are displaceable relative to the first lens-element group along the optical axis, wherein the second lens-element group is arranged between the first lens-element group and the diaphragm, and wherein the third and fourth lens-element groups are arranged between the diaphragm and the light exit opening.

In this way, an objective is provided in which at least four separate lens-element groups are arranged on a common optical axis. The first lens-element group (as viewed from the light entrance opening or front side) is stationary. Downstream thereof there follow along the optical axis three further lens-element groups, which are in each case displaceable relative to the first lens-element group along the optical axis. Selectively, the objective in some refinements has a fifth lens-element group, which is arranged in the region of the light exit opening and is stationary. The lens-element groups together generate an image on an image sensor coupled to the objective via the interface. On account of the individual displaceability of the three lens-element groups, the new objective can be set to different imaging conditions very flexibly. As explained below on the basis of a preferred exemplary embodiment, the new objective makes possible, in particular, a variable setting of the magnification and a variable setting of the operating distance. In the preferred exemplary embodiments, the new objective is telecentric over the entire setting range of the magnification and over the entire setting range of the operating distance, which can be achieved very well with the aid of the axially displaceable diaphragm. The individual adjustability of the three lens-element groups furthermore makes it possible to realize a constant magnification over the entire variation range of the operating distance or a constant focusing to an operating distance over the entire usable magnification range. These properties make it possible for the first time to measure a measurement object having great height differences parallel to the optical axis of the objective with constant parameters, without the optical sensor as such having to be moved nearer to the measurement object or further away from the measurement object. This last makes possible very fast measurements at a multitude of measurement points. The stationary first lens-element group furthermore has the advantage that the “disturbing contour” of the optical sensor in the measurement volume of the coordinate measuring machine is always the same. The risk of the sensor colliding with the measurement object is reduced. Furthermore, the variable setability makes it possible to dispense with changeable optics, which were used in part in previous coordinate measuring machines in order to perform different measurement tasks.

In a further refinement, the first and second lens-element groups together define a focal point lying between the second and third lens-element groups, wherein the control curve for the diaphragm and the control curve for the second lens-element group are coordinated with one another such that the diaphragm is always arranged at the focal point.

This refinement ensures for the new objective, despite the flexible variation possibilities, an at least object-side telecentricity over all magnifications and operating distances. The object-side telecentricity is advantageous in order to determine in particular the depth of bores, projections or recesses on a measurement object because the “view” of the measurement object is largely constant despite the different operating distances in these cases. A perspective distortion of the measurement object is advantageously avoided by virtue of an object-side telecentricity.

In a further refinement, the diaphragm has a variable diaphragm aperture, which preferably varies in a manner dependent on the position of the diaphragm along the optical axis.

In this refinement, the new objective has a further degree of freedom, namely the aperture of the diaphragm. This makes it possible to vary the numerical aperture of the objective and thus to vary the achievable resolution of the objective. In preferred exemplary embodiments, the abovementioned control curves including the individual control curve for the diaphragm aperture are embodied such that the objective offers an operating mode with a constant image-side aperture over different operating distances. This operating mode is advantageous in order to be able to operate with a constantly high measurement accuracy over different operating distances.

In the preferred exemplary embodiments, the diaphragm is situated centrally with respect to the optical axis, to be precise with a centering error that is less than 20 μm and is preferably less than 10 μm. The diaphragm is preferably an iris diaphragm that is drivable individually in a motor-operated manner, wherein the driving is effected using a control curve belonging to the set of curves mentioned above. These exemplary embodiments enable a simple implementation and a constantly high measurement accuracy over the entire operating range.

In a further refinement, the objective has a multitude of slides and motor-operated drives, wherein the second, third and fourth lens-element groups and the diaphragm are in each case coupled to a dedicated slide that is adjustable along the optical axis, and wherein the slides are individually movable with the aid of the motor-operated drives.

In this refinement, the elements that are adjustable along the optical axis are in each case coupled to a dedicated drive. In some exemplary embodiments, the drive is a stepper motor, which preferably operates in full-step operation since this results in a low heat input into the objective. The refinement enables a modular and comparatively cost-effective realization. As an alternative, it is also possible to use DC motors, in particular in a brushless embodiment.

In a further refinement, the first lens-element group has a positive refractive power. Preferably, the second lens-element group has a negative refractive power, the third lens-element group has a positive refractive power and the fourth lens-element group has a negative refractive power.

In practical experiments this refinement has proved to be very advantageous for achieving a compact design and a small disturbing contour of the objective in the measurement volume of the new coordinate measuring machine.

In a further refinement, in the objective body between the first and second lens-element groups there is a clearance, in which preferably a beam splitter is arranged. In the preferred variant, a further interface at the objective body is situated at the level of the beam splitter, via which further interface a defined illumination can be coupled into the objective and/or an image generated by the first lens-element group can be coupled out.

In this refinement, between the first lens-element group and the displaceable second lens-element group there is a defined minimum distance that cannot be undershot by the second lens-element group. The clearance makes it possible to accommodate a beam splitter in the optical beam path and/or to introduce the chromatic assembly into the objective between the first lens-element group and the second lens-element group. The refinement increases the flexibility of the new objective since, in particular, it also facilitates the coupling-in of defined illuminations for different sensor principles.

In further exemplary embodiments, a stripe pattern or some other structured illumination can be coupled in via the further interface, and is analyzed for example on the basis of the image captured by the camera in order to measure a measurement object. Preferably, a further clearance is provided between the fourth lens-element group and the light exit opening of the objective, a beam splitter likewise being arranged in said further clearance. A third interface is preferably arranged at the level of the further beam splitter, such that the input and output coupling of illumination and/or signals is also possible downstream of the optical system comprising the four lens-element groups. The flexibility and the scope of use of the new objective and of the corresponding coordinate measuring machine are thus increased even further.

In a further refinement, the objective has a separate cover glass, which is arranged upstream of the first lens-element group in the region of the light entrance opening.

In this refinement, light which enters into the beam path of the objective via the light entrance opening firstly impinges on the cover glass and only afterwards passes through the series of lens-element groups to the light exit opening. The arrangement of a separate cover glass upstream of the first lens-element group is an unusual measure for measurement objects since the cover glass in any case influences the optical properties of the objective or the beam path thereof. In the preferred exemplary embodiments, the optical properties of the cover glass are therefore taken into account in the correction of the lens-element groups, that is to say that the cover glass is included in the overall correction of the objective. The provision of a separate cover glass upstream of the first lens-element group is unusual particularly if the first lens-element group is designed for generating a defined longitudinal chromatic aberration, which is the case in preferred exemplary embodiments of the new objective. However, the refinement has the advantage that a separate cover glass can be more easily cleaned and exchanged, if appropriate, if the light entrance opening of the objective is soiled or even damaged during everyday operation. Accordingly, the new objective in preferred exemplary embodiments is designed such that the separate cover glass is held reversibly and non-destructively releasably in the objective body.

In a further refinement, the first, second, third and fourth lens-element groups in each case consist of at least two lens elements. In the preferred exemplary embodiments, each lens-element group comprises at least one cement element, i.e. at least two individual lens elements in each of the four lens-element groups are connected permanently and over a large area along their optically active surfaces.

This refinement reduces the number of interfaces and therefore contributes to a high imaging quality over a large spectral operating range. In one preferred exemplary embodiment, the four lens-element groups merely form fourteen interfaces.

It goes without saying that the features mentioned above and those yet to be explained below can be used not only in the combination respectively indicated, but also in other combinations or by themselves, without departing from the scope of the present invention.

### BRIEF DESCRIPTION OF THE DRAWINGS

Exemplary embodiments of the invention are illustrated in the drawing and are explained in greater detail in the following description. In the figures:

FIG. 1 shows an exemplary embodiment of the new coordinate measuring machine in a view obliquely from the front,

FIG. 2 shows a schematic illustration of the objective from the coordinate measuring machine from FIG. 1,

FIG. 3 shows a sectional view of the lens-element groups of the objective from FIG. 2 in accordance with one exemplary embodiment, wherein the lens-element groups are illustrated in five different operating positions representing different magnifications with the same operating distance in each case,

FIG. 4 shows a further sectional view of the objective from FIG. 2 with five different operating positions representing five different magnifications with a different operating distance from that in FIG. 3,

FIG. 5 shows a further sectional view of the objective from FIG. 2, the illustration showing the position of the lens-element groups along the optical axis with in each case the same magnification for five different operating distances,

FIG. 6 shows a further exemplary embodiment of the apparatus,

FIG. 7 shows yet another exemplary embodiment of the apparatus,

FIG. 8 shows a schematic illustration of the imaging of an object inclined relative to an optical axis of an objective,

FIG. 9 shows a schematic plan view of an exemplary embodiment of the apparatus,

FIG. 10 shows a schematic illustration of the optional input coupling of a light beam having a specific wavelength in an illumination assembly, and

FIGS. 11a to 11d show exemplary embodiments for using pivotable mirror elements or microscanners.

### DETAILED DESCRIPTION OF THE PREFERRED EMBODIMENTS

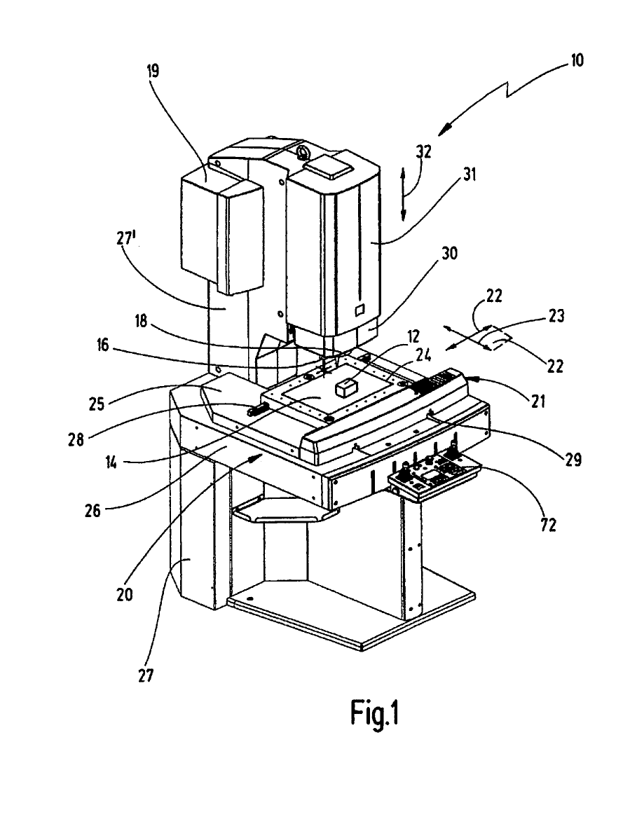

FIG. 1 shows an apparatus 10 for inspecting a measurement object 12 arranged on a workpiece carrier 14. In the embodiment illustrated, the apparatus 10 is a coordinate measuring machine. The measurement object 12 is measured by means of one or a plurality of optical sensors 18. Selectively, one or a plurality of tactile sensors 16 can additionally also be provided.

Coordinate measuring machines are generally known in the prior art. They are used, for example in the context of quality assurance, to check workpieces or to determine the geometry of a workpiece completely in the context of so-called “reverse engineering”. Furthermore, a wide variety of further application possibilities are conceivable, thus for example including the additional use for inspecting surfaces.

In such coordinate measuring machines, different types of sensors can be used to detect the coordinates of a workpiece to be measured. By way of example, sensors that effect tactile measurement are known for this purpose, such as are sold for instance by the applicant under the product designation “VAST”, “VAST XT” or “VAST XXT”. In this case, the surface of the workpiece to be measured is probed with a probe pin whose coordinates in the measurement space are continuously known. Such a probe pin can also be moved along the surface of a workpiece, such that in such a measuring process in the context of a so-called “scanning method” a multitude of measurement points can be detected at defined time intervals.

Furthermore, it is known to use optical sensors which enable the coordinates of a workpiece to be detected contactlessly. Examples of such optical sensors are the optical sensor sold by the applicant under the product designations “ViScan” “LineScan” or “Eagle Eye”.

The sensors can then be used in various types of measurement set-ups. One example of such a measurement set-up is a table set-up, as shown in FIG. 1. One example of such a table set-up is the product “O-INSPECT” from the applicant. In such a machine, both an optical sensor and a tactile sensor are used to carry out different inspection tasks on one machine and ideally with a single clamping of a workpiece to be measured. In this way, many inspection tasks for example in medical technology, plastics technology, electronics and precision mechanics can be carried out in a simple manner. It goes without saying that, furthermore, various other set-ups are also conceivable.

Such sensor systems or sensor heads that carry both tactile and optical sensors are becoming increasingly important in coordinate measuring technology. A combination of tactile and optical sensors makes it possible to combine in a single coordinate measuring machine the advantages of the high accuracy of a tactile measuring system with the speed of an optical measuring system. Furthermore, calibration processes during sensor changes are avoided, as is possible reclamping of a workpiece.

Traditionally, the sensor head, which can also be designated as sensor system, is connected to a carrier system that supports and moves the sensor system. Various carrier systems are known in the prior art, for example gantry systems, stand, horizontal arm and arm systems, all kinds of robot systems and finally closed CT systems in the case of sensor systems operating with X-rays. In this case, the carrier systems can furthermore have system components that enable the sensor head to be positioned as flexibly as possible. One example thereof is the rotary-pivoting articulated joint from the applicant sold under the designation “RDS”. Furthermore, various adapters can be provided in order to connect the different system components of the carrier system among one another and to the sensor system.

Consequently, the use of the apparatus 10 and the coordinate measuring machine 100 are not restricted to the table set-up illustrated in FIG. 1 and the corresponding carrier system, but rather can also be used with all other types of carrier systems. Furthermore, the apparatus 10 can also generally be used in multi-sensor measuring systems or in a material microscope.

The apparatus 10 furthermore has a measuring table 20. A positioning device 21 is situated on the measuring table 20. Said positioning device is provided, in particular, for positioning the measurement object 12 parallel to an X-axis 19 and to a Y-axis 23. In this case, the X-axis 19 and the Y-axis 23 span a measuring plane.

By way of example, an X-table 24 and a Y-table 25 can be provided for positioning purposes. The X-table 24 is movable parallel to the X-axis 21 and the Y-table 25 is movable parallel to the Y-axis 19. Both are arranged on a baseplate 26. The baseplate 26 is carried by a machine frame 27 and 27′.

The movement of the X-table 24 and of the Y-table 25 is guided by linear guides in the X-direction 28 and in linear guides in the Y-direction 29. This set-up corresponds to the so-called “table set-up”. As already explained above, other carrier systems are also conceivable.

The apparatus 10 furthermore has a measuring head 15. One or a plurality of tactile sensors 16 can be arranged on the measuring head 15. Furthermore, the apparatus 10 is arranged on the measuring head 15. Furthermore, one or a plurality of further optical sensors 18 can also be arranged on or in the measuring head 15. The measuring head 15 therefore serves to couple the one or the plurality of optical sensors 18 and possibly a tactile sensor 16 to a carrier structure, for example a Z-slide 30. The measuring head 15 can be a closed housing construction, but it can also be embodied in an open fashion. By way of example, the measuring head 15 can also have the form of a simple plate on which the one or the plurality of optical sensors 18 and possibly the tactile sensor 16 are fixed. Furthermore, all further possible forms for coupling the one or the plurality of optical sensors 18 and possibly the tactile sensor 16 to the carrier structure are also conceivable.

The measuring head 15 is held on the Z-slide 30, which is guided in a slide housing 31 parallel to a Z-axis 32. Said Z-axis 32 is perpendicular to the X-axis 22 and to the Y-axis 23. The X-axis 22, the Y-axis 23 and the Z-axis 32 thus form a Cartesian coordinate system.

The apparatus 10 furthermore has an operating console 72. The individual elements of the apparatus 10 can be driven by means of the operating console 72. Furthermore, it is possible to predetermine inputs at the apparatus 10. In principle, it can also be provided that a display device (not illustrated) is arranged in the operating console 72 or elsewhere, in order to convey measurement value outputs to a user of the apparatus 10.

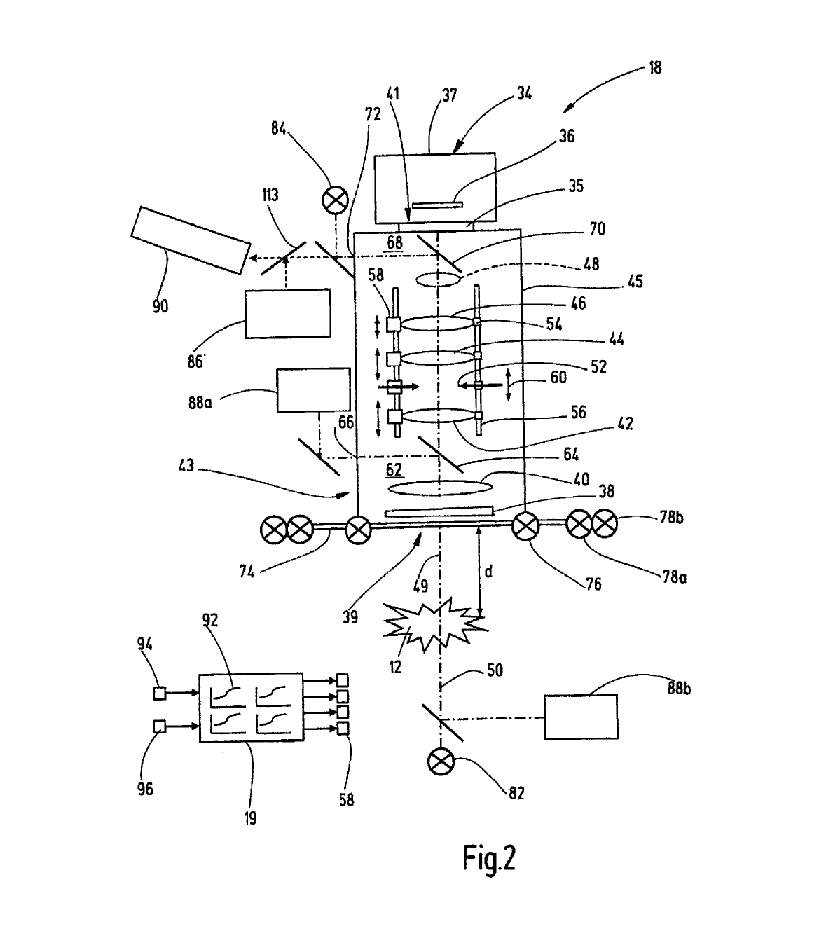

FIG. 2 shows one preferred exemplary embodiment of the optical sensor 18, wherein the optical sensor 18 in this exemplary embodiment strictly speaking comprises a plurality of optical sensors which can be selectively present and used. The new objective can furthermore be combined with further optical sensors, for instance with a deflectometrically measuring sensor.

The sensor 18 comprises a objective 43 having an objective body 45. In typical exemplary embodiments, the objective body 45 is a tube having a light entrance opening 39 and a light exit opening 41, which are arranged at opposite ends of the tube. In principle, however, the objective body 45 can also have a form that deviates from a tube.

An interface 35 serving for connecting a camera 34 to an image sensor 36 is formed at the light exit opening 41. In preferred exemplary embodiments, the interface 35 is a standardized or widely used interface for coupling cameras and lenses, for instance a so-called F-mount or a so-called C-mount. In some exemplary embodiments, however, the interface 35 is a proprietary interface that makes it possible, in particular, to connect the housing 37 of the camera 34 directly to the objective body 45. In principle, it is also possible to use other standardized or proprietary interfaces for connecting the camera 34 to the objective body 45.

In the region of the light entrance opening 39, which defines the distal end of the objective 43, a cover glass 38 is arranged in the objective body 45 or on the objective body 45. In some exemplary embodiments, the cover glass 38 can be a screw-type glass that is screwed into a threaded mount at the distal end of the objective body 45. In other exemplary embodiments, the cover glass 38 can be pushed, clipped or adhesively bonded into a suitable recess on the objective body 45 or can be connected to the objective body 45 in a positionally fixed fashion in some other way. In the preferred exemplary embodiments, the cover glass 38 is connected to the objective body 45 in such a way that a user of the coordinate measuring machine 10 can exchange the cover glass 38 without damaging the objective 43.

In the exemplary embodiment illustrated, the cover glass 38 is a wedge-shaped glass plate, the thickness of which increases from one edge to the other edge, as is illustrated in the simplified sectional illustration in FIG. 2. In this case, the cover glass 38 has a wedge angle chosen such that a reflection at the front side (towards the distal end of the objective 43) or the rear side of the cover glass 38 does not reach the image sensor 36 of the camera 34. In the exemplary embodiment illustrated, the cover glass 38 is arranged in such a way that its front side is inclined or lies obliquely with respect to the light entrance opening 39, while the rear side is likewise arranged slightly obliquely with respect thereto.

In other exemplary embodiments, a cover glass having plane-parallel front and rear sides could be arranged slightly obliquely with respect to the image sensor 36 and/or the optical axis (explained in even greater detail below) of the objective 43.

In further exemplary embodiments, the cover glass 38 can be realized in the form of a thin film clamped in the region of the light entrance opening 39 of the objective 43. In some exemplary embodiments, the cover glass can be polarizing, such that the light passing through is polarized, and/or the cover glass can comprise a color filter for suppressing ambient light.

In the exemplary embodiment illustrated, a lens-element system having a first lens-element group 40, a second lens-element group 42, a third lens-element group 44 and a fourth lens-element group 46 is arranged between the cover glass 38 and the light exit opening 41 of the objective 43. In some exemplary embodiments, a fifth lens-element group 48 is also arranged between the fourth lens-element group 46 and the light exit opening 41, said fifth lens-element group being represented here by dashed lines. The lens-element groups 40-48 are arranged in the objective body 45 one behind another between the light entrance opening 39 and the light exit opening 41 along a longitudinal axis 49 of the objective body 45. In the exemplary embodiment illustrated, a light beam that passes through the lens-element groups 40-48 in their respective middle or center experiences no deflection, such that the longitudinal axis 49 coincides with an optical axis 50 of the objective 43.

A diaphragm 52 is arranged between the second lens-element group 42 and the third lens-element group 44. In the preferred exemplary embodiments, the diaphragm 52 is an iris diaphragm, i.e. a diaphragm whose clear internal diameter can be varied.

The second, third and fourth lens-element groups 42, 44, 46 and the diaphragm 52 are in each case coupled to a dedicated slide 54 that can be moved along two guide rails 56. Furthermore, the three lens-element groups and the optical diaphragm 52 in this exemplary embodiment are in each case coupled to an electrical drive 58. With the aid of the drives 58, the second, third and fourth lens-element groups and the diaphragm 52 can be moved parallel to the optical axis 50, as is indicated on the basis of the arrows 60. In contrast thereto, the first lens-element group 40 and the optional fifth lens-element group 48 in the preferred exemplary embodiments are arranged in a stationary fashion in the objective body 45.

As can be discerned in FIG. 2, in some exemplary embodiments there is a clearance 62 between the first lens-element group 40 and the second lens-element group 42, said clearance remaining even if the second lens-element group 42 were positioned to a minimum distance with respect to the first lens-element group 40. In the preferred exemplary embodiments, a beam splitter 64 is arranged in the clearance 62 on the optical axis 50 in order selectively to couple in or out light from a further interface 66 of the objective 43. In the preferred exemplary embodiments, the second interface 66 is arranged approximately at the level of the beam splitter 64 on the lateral circumference of the objective body 45.

In a similar manner, in some exemplary embodiments of the objective 43, there is a further clearance 68, in which a beam splitter 70 is likewise arranged, between the fourth lens-element group 46 and the light exit opening 41. A further interface 72, via which light can be coupled in and/or out, is situated at the level of the beam splitter 70. In the exemplary embodiment illustrated, the beam splitter 70 is arranged between the fifth lens-element group 48 and the light exit opening 41. Alternatively or supplementarily thereto, the beam splitter 70 could be arranged between the fourth lens-element group 46 and the fifth lens-element group 48, which of course presupposes a corresponding clearance.

In preferred exemplary embodiments, the objective 43 has in the region of the light entrance opening 39 a holder 74, on which various light sources 76, 78 are arranged. In the exemplary embodiment illustrated, the holder 74 carries a ring light having a multitude of light sources 78a, 78b arranged all around the objective body 45 at different radial distances. In some exemplary embodiments, the light sources 78a, 78b are able to generate different-colored light, for instance white light, red light, green light and blue light and mixtures thereof. The light sources 78a, 78b can be used for producing different illumination scenarios at different distances in front of the light entrance opening 39. By way of example, the reference numeral 12 schematically indicates a measurement object 12 positioned at a distance d from the light entrance opening 39 of the objective 43. The distance d represents an operating distance between the objective 43 and the measurement object 12, wherein said operating distance can be set in a variable manner on the basis of the focusing of the objective 43.

In the present exemplary embodiment, the light sources 76 are light sources that are integrated into the objective body 45. In some exemplary embodiments, the light sources 76 are integrated into the objective body 45 outside the lens-element system, as is illustrated in FIG. 2. In other exemplary embodiments (alternatively or supplementarily), light sources 76 can be integrated into the objective body 45 in such a way that the light generated by the light sources 76 emerges from the objective body 45 at least through some of the lens-element groups and, if appropriate, the cover glass 38. In this case, the light entrance opening 39 is simultaneously also a light exit opening.

The light sources 76, 78 make it possible to illuminate the measurement object 12 in a variable manner in order selectively to generate bright-field and/or dark-field illumination. Both cases involve reflected light that impinges on the measurement object 12 from the direction of the objective 43.

Furthermore, in preferred exemplary embodiments, the coordinate measuring machine 10 has a further light source 82, which enables transmitted-light illumination of the measurement object 12. Accordingly, the light source 82 is arranged below the measurement object 12 or below the workpiece support of the coordinate measuring machine 10. In the preferred exemplary embodiments, therefore, the coordinate measuring machine 10 has a workpiece support 12 provided with a glass plate in order to enable the transmitted-light illumination.

Finally, the optical sensor 18 in these exemplary embodiments has a reflected-light illumination device 84, which here can be coupled to the interface 72 via a further beam splitter. The light source 84 can couple light into the entire beam path of the objective 43 via the interface 72 and the beam splitter 70. The light coupled in is projected onto the measurement object 12 here via the lens-element system of the first to fourth (fifth) lens-element groups.

In the same way, different illuminations can be coupled into the beam path of the objective 43 via the interface 66 and, in principle, also via the light exit opening 41. By way of example, a grating projector is represented by the reference numeral 86. The grating projector generates a structured light pattern which is coupled into the beam path of the objective 43 via two beam splitters and the interface 72 in this exemplary embodiment. In some exemplary embodiments, a light source can be a laser pointer with which individual measurement points on the measurement object 12 can be illuminated in a targeted manner. In other exemplary embodiments, a light source can generate a structured light pattern, for instance a stripe pattern or grating pattern, which is projected onto the measurement object 12 via the lens-element system of the objective 43.

As is illustrated in FIG. 2, the objective 43 can be combined in various ways with optical sensors which serve for optically measuring the measurement object 12 alternatively or supplementarily to the camera 34. In FIG. 2, merely by way of example, a first confocal white light sensor 88a is coupled to the interface 66. Alternatively or supplementarily, a confocal white light sensor 88b can be coupled into the illumination path for the transmitted-light illumination 82 for example via a beam splitter. The sensors 88a and 88b can carry out a punctiform measurement. As will be explained below, a new type of optical distance measurement is proposed in the present case, however, using the clearance 62.

The reference numeral 90 designates a sensor device. The latter can be used to determine the height position of the measurement object 12 parallel to the optical axis 50 on the basis of a determination of the focal position. Moreover, the sensor device 90 is used as a sensor in a triangulation method, as will be explained below. Furthermore, an optical measurement of the measurement object 12 is possible with the aid of the camera 34 and a suitable image evaluation, as is known to the relevant persons skilled in the art in this field.

In the preferred exemplary embodiments, the objective 43 has a wide scope of use on account of the movable lens-element groups 42, 44, 46 and the adjustable diaphragm 52. In the preferred exemplary embodiments, a multitude of control curves 92 are stored in a memory of the evaluation and control unit 19 or some other suitable storage device. In the preferred exemplary embodiments, the multitude of control curves 92 form a D curve set which can be used to set the magnification and the focusing of the objective 43 in numerous freely selectable combinations. In the exemplary embodiment illustrated, a user can input a desired magnification 94 and a desired focusing 96 into the evaluation and control unit 19. With the aid of the control curves 92 and in a manner dependent on the desired magnification 94 and desired focusing 96, the evaluation and control unit 19 determines individual positions of the second, third and fourth lens-element groups along the optical axis 50 and an individual position and aperture of the diaphragm 52. In some exemplary embodiments of the new method, the user can vary the operating distance d from a measurement object by varying the focusing, without the sensor 18 having to be moved relative to the measurement object with the aid of the sleeve 14. By way of example, it is thus possible to measure structures on the surface of a measurement object 12 and structures at the bottom of a bore (not illustrated here) of the measurement object 12 by means of only the focusing of the objective 43 being varied, with constant magnification, such that in one case the structure on the surface of the measurement object 12 and in the other case the structure at the bottom of the bore lies in the focal plane of the objective 43.

In other variants, with a constant or changing operating distance d, which denotes a distance between the measurement object 12 and a first disturbing contour, namely the light entrance opening 39 of the objective 43, a user can vary the magnification of the objective 43 in order that, for example, details of a measurement object 12 previously measured “from a bird's eye view” are measured again.

Furthermore, in some exemplary embodiments, a user can vary the numerical aperture of the objective 43 by opening or closing the diaphragm 52 in order in this way to achieve a constant resolution with different operating distances d. Furthermore, a user can vary the magnification, focusing, numerical aperture individually or in combination with one another in order to optimally adapt the objective 43 to the properties of the different sensors 36, 88, 90.

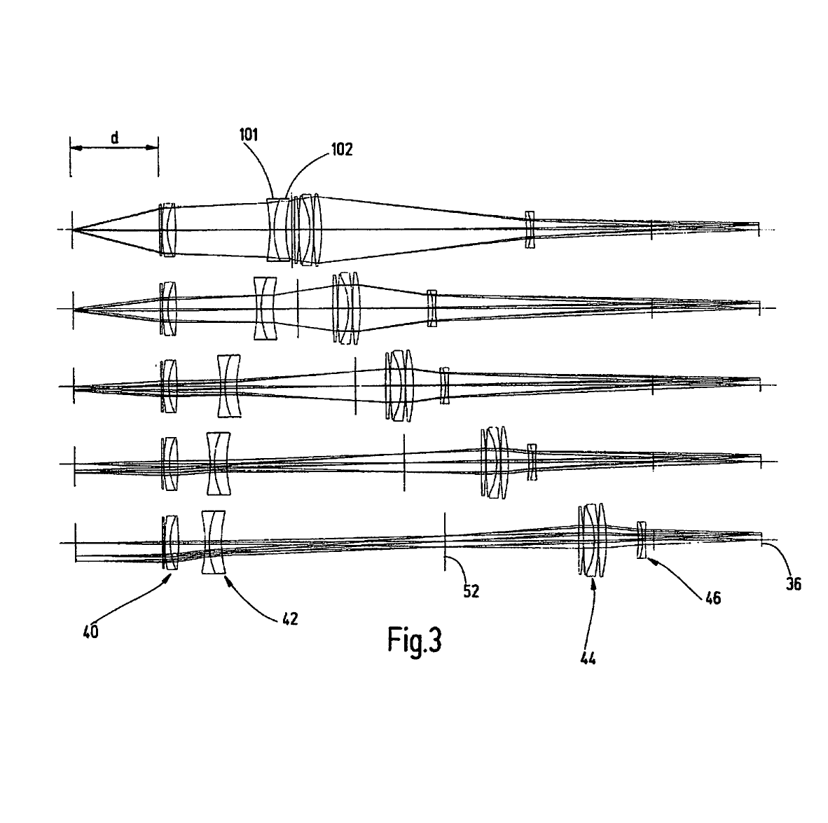

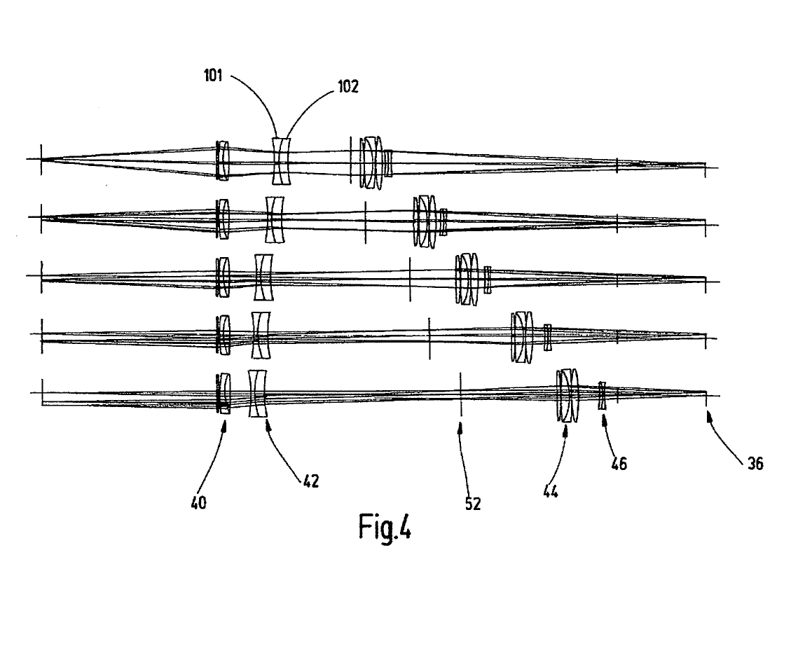

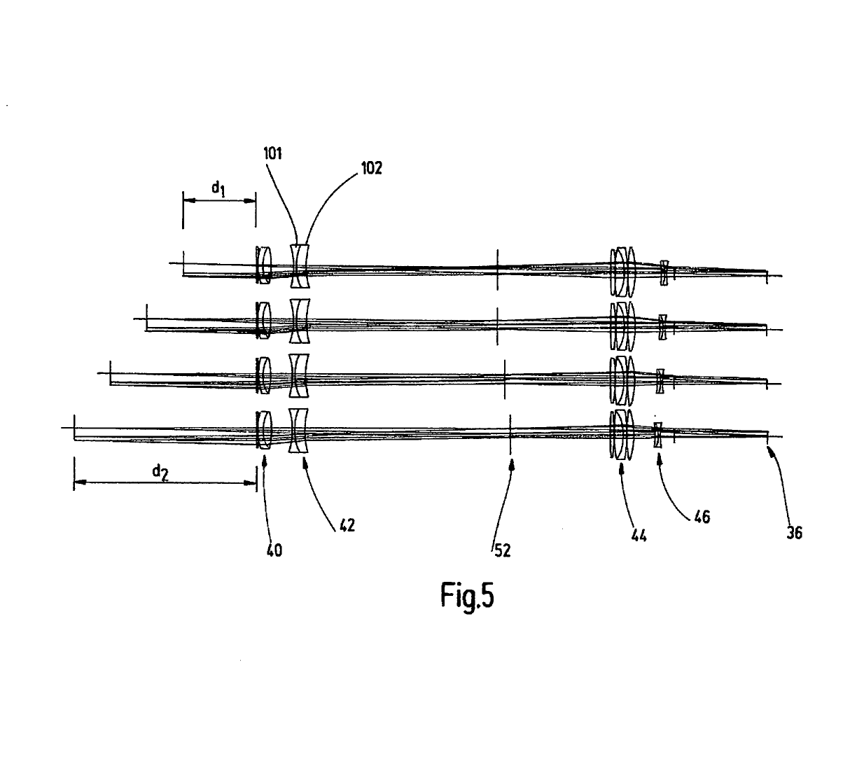

FIGS. 3 to 5 illustrate the positions of the lens-element groups 40, 42, 44, 46 and the position of the diaphragm 52 for different operating distances d and different magnifications. As can be discerned on the basis of the sectional views, each lens-element group has a plurality of lens elements 100, 102, wherein, in this exemplary embodiment, at least one cement element consisting of at least two lens elements 101, 102 is used in each lens-element group. Some of the lens-element groups have further separate lens elements. At a high magnification, the second and third lens-element groups are close together, wherein the actual distance between the second and third lens-element groups is additionally dependent on the operating distance d. As can be discerned on the basis of FIG. 3, the second and third lens-element groups are closer together in the case of a relatively small operating distance d than in the case of a relatively large operating distance.

With decreasing magnification, the second and third lens-element groups move apart from one another, the second lens-element group approaching the first lens-element group. At the high magnification, the first and second lens-element groups focus a (virtual) image formed by the measurement object upstream of the diaphragm 52. The fourth lens-element group acts as a projective system in this case. It shifts the image into the plane of the image sensor 36. With decreasing magnification, the image formed by the first and second lens-element groups moves further away from the diaphragm. The third and fourth lens-element groups approach one another and with joint positive refractive power image the virtual image onto the plane of the image sensor 36.

In all preferred exemplary embodiments, the diaphragm 52 in each case follows the focal point of the subsystem formed from the first and second lens-element groups. This enables a good field correction with the aid of the third and fourth lens-element groups.

In one preferred exemplary embodiment, a measurement object is arranged at a distance of between 0.8 and 2 times the focal length of the lens-element group 1. The first lens-element group has a positive refractive power. The second lens-element group has a negative refractive power. The third lens-element group has a positive refractive power, and the fourth lens-element group once again has a negative refractive power. The second, third and fourth lens-element groups are in each case achromatically corrected, while the first lens-element group produces a defined longitudinal chromatic aberration. The diaphragm 52 is situated in each case at the image-side focal point of the subsystem formed from the first and second lens-element groups. A corresponding control curve for the axial position of the diaphragm 52 ensures an object-side telecentricity. The change in the diaphragm diameter allows an object-side aperture adapted to the respective magnification and object structure. The virtual image formed by the first and second lens-element groups is imaged by the third and fourth lens-element groups to a defined location arranged at a defined fixed distance from the first lens-element group. In the preferred exemplary embodiments, the image sensor 36 is situated at said defined location.

The optional fifth lens-element group transforms the image by a constant absolute value with a scalar proportion of the total magnification. In the preferred exemplary embodiments, the total magnification is real without an intermediate image. The design of the system ensures, over the total magnification range, an exit pupil position relative to the image downstream of the fourth lens-element group between half and double the distance to the measurement object. This is advantageous in order to be able to couple illumination light into the objective 43 via the interface 72 and/or the interface 35 with low losses even without a strict image-side telecentricity.

The focal length of the subsystem formed from the first and second lens-element groups increases towards larger object fields and the diaphragm 52 tracks the lens-element groups moving in the direction of the image sensor 36. In this case, the beam heights at the third and fourth lens-element groups are limited on account of the diaphragm, which enables a good overall correction of the imaging. The overall system is underdetermined by the paraxial basic data of magnification, focusing, telecentricity and numerical aperture. With the aid of the control curve for the axial position of the diaphragm, it is possible to achieve a balanced correction of the image aberrations over a large adjustment range of the magnification. In some exemplary embodiments, the ratio between maximum magnification and minimum magnification is greater than 10 and preferably greater than 15.

In the preferred exemplary embodiments, the objective 43 can have transverse chromatic aberrations in order to enable a simple and cost-effective construction. This has the consequence that light and images of different colors can have a small offset transversely with respect to the optical axis 50. In preferred exemplary embodiments, the transverse chromatic aberration is corrected on the basis of mathematical correction calculations, which is possible in the preferred exemplary embodiments because the aberration image as such is continuous.

In some exemplary embodiments of the objective 43, the beam splitter 64 and the cover glass 38 are embodied such that a polarization-optical suppression with extraneous light is achieved. For this purpose, the beam splitter 64 is embodied as a polarizing beam splitter, and the cover glass 38 is a λ/4 plate. In this way, light that arises for example as a result of internal reflections in the objective body is deflected by the beam splitter 64. Only light that passed with outgoing and return path through the λ/4 plate was rotated in each case by 45° in the direction of polarization and can then pass through the beam splitter 64 by virtue of the direction of polarization rotated by 90° in total in the direction of the camera 34.

In preferred exemplary embodiments, mount parts of the lens-element groups are blackened, and the lens-element interfaces are provided with antireflection coatings. Interfaces of adjacent lens elements are cemented as much as possible. The individual assemblies are weight-optimized in order to enable rapid movements of the movable lens-element groups and diaphragm.

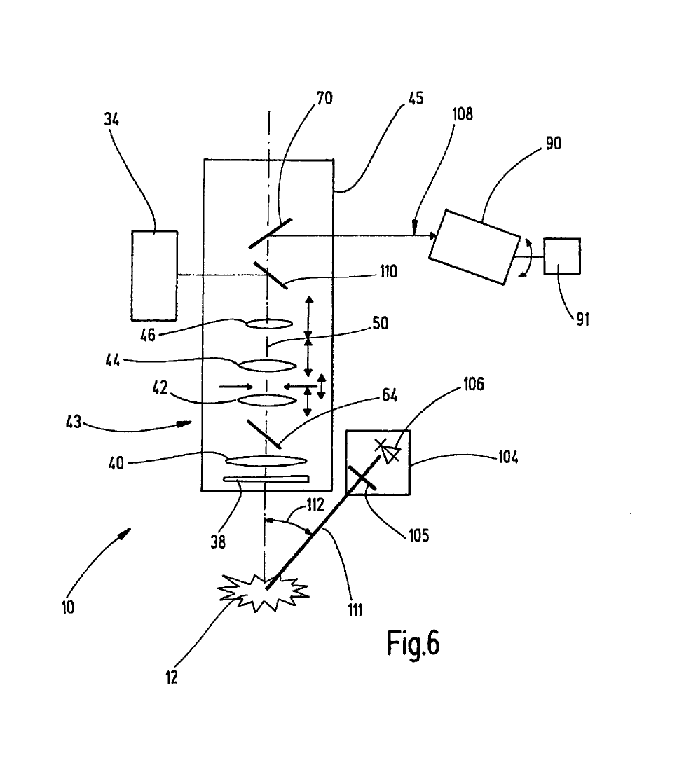

FIG. 6 illustrates an exemplary embodiment of the apparatus 10 with its individual components.

Identical elements are identified by identical reference signs therein and will not be explained any further below.

As can be discerned, the camera 34 is not arranged in alignment with the optical axis of the objective, but rather arranged laterally by means of a beam splitter 110. However, this arrangement should be understood to be merely by way of example. It goes without saying that the camera 34 can also be arranged as illustrated in FIG. 3. Likewise, the order of the beam splitters 70 and 110 can also be set up oppositely.

An illumination device 104 can have an optics 105, for example, which shapes the light emitted by a light source, for example a laser or an LED, in a suitable manner, as will be explained below. An illumination light beam 111 generated in this way is then incident on the measurement object 12 at a triangulation angle 112. The light beam is reflected and/or scattered by the measurement object 12 and is imaged as incident radiation 108 onto the sensor device 90 through the objective 43. The sensor device 90 has a tilting device 91, which tilts the sensor device 90 relative to the incident radiation 108.

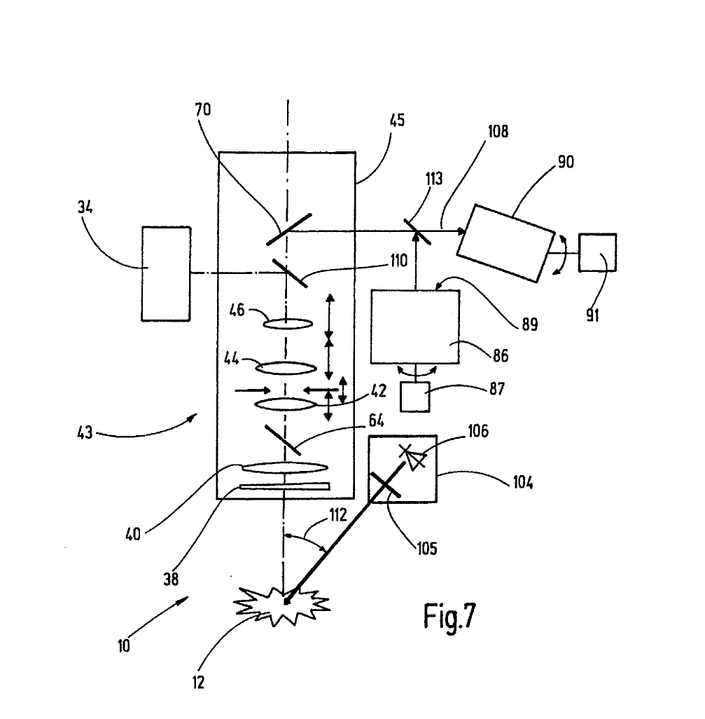

FIG. 7 illustrates a further exemplary embodiment of the apparatus 10. Elements identical to those in FIG. 6 are in this case identified by identical reference signs and will not be explained any further below.

In this exemplary embodiment, alongside the use as sensor device in a triangulation measuring method, the sensor device 90 is also used as sensor device in a so-called GRID autofocus system or light grating focusing system. An autofocus beam splitter 113 is thus provided, which couples in the light emitted from an emission plane 89 of the autofocus illumination device 86. In addition to the possibility of the tilting of the sensor device 90, moreover, it is furthermore possible to provide a further tilting device 87 for tilting the emission plane 89.

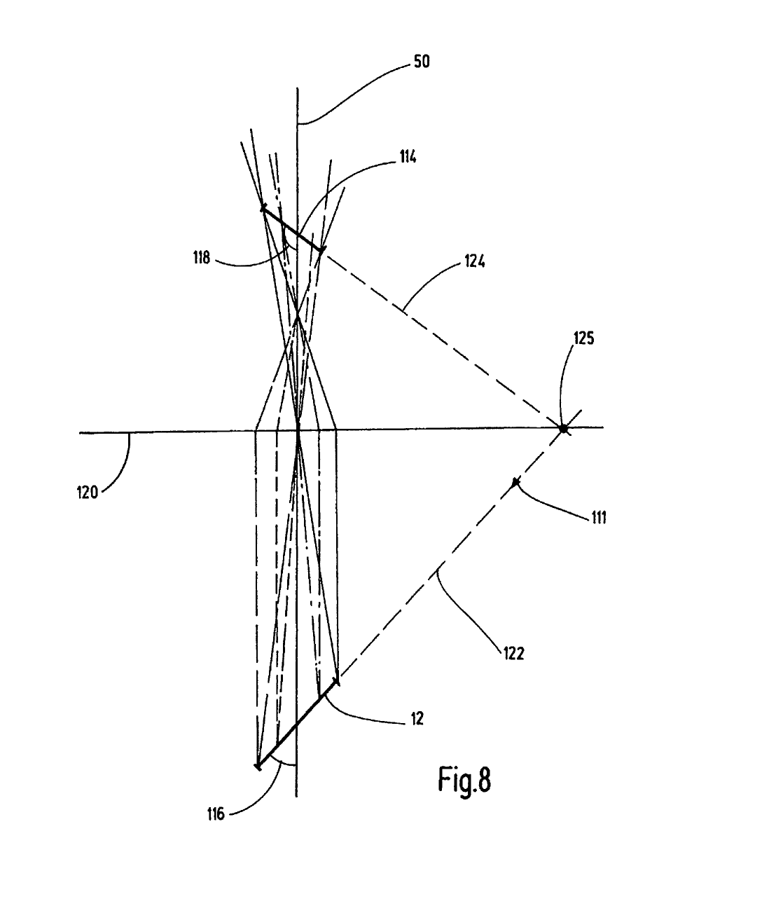

FIG. 8 schematically illustrates once again the reason for the necessity of tilting the sensor device 90 if sharp imaging on the entire sensor device 90 is intended to be effected. If the measurement object 12 is irradiated with the radiation in the direction 111 of incidence obliquely with respect to the optical axis 50 of the objective, an object to be imaged by means of the objective 41 is arranged at an angle 116 with respect to the optical axis 50 of the lens-element group of the objective 43. The illustration schematically shows the individual beam paths which have the effect that an image 114 of the objective is imaged in an inclined manner at an angle 118 with respect to the optical axis 50. For sharp imaging, therefore, the sensor device 90 also has to be arranged in a manner inclined by a corresponding angle 118. Ultimately, it is necessary to provide for an effective or active principal plane 120 of the objective 43, an object plane 122 and an image plane 124 to intersect according to the Scheimpflug condition at a point 125 or a common line or—owing to the finite thickness of the lens elements—lines respectively situated close together. Areal sharp imaging can then be effected by means of the objective 43.

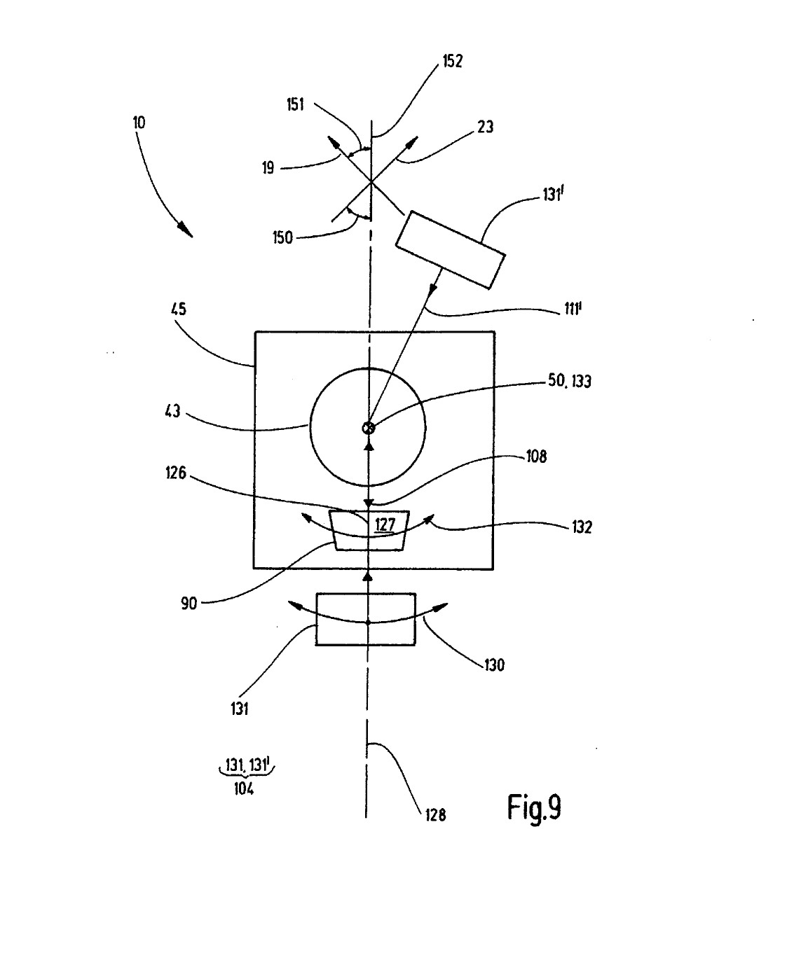

FIG. 9 schematically shows a plan view of the apparatus 10. Identical elements are once again identified by identical reference signs.

Alongside the substantive matter illustrated in FIG. 8, consideration must be given to ensuring that in three-dimensional space, too, the emitting and receiving surfaces and also the imaging system are oriented with respect to one another in such a way that imaging with the highest possible quality can be obtained.

Specifically, this is the case when a normal 126 to a sensor plane 127 of the sensor device 90, the direction 111 of incidence of the illumination device 104 and the optical axis 50 lie in a common plane 128. In principle, provision can be made for the illumination device 104 to have a plurality of illumination assemblies 131, 131′ in order to irradiate the measurement object 12 with different directions 111, 111′ of incidence. In order to ensure this, it can furthermore be provided that one or a plurality of the illumination assemblies 131 can be pivoted about a pivoting axis 133, thus resulting in a pivoting direction 130. In this case, it can be provided, in particular, that the pivoting axis 133 is the optical axis 50. However, this need not necessarily be the case.

Accordingly, it can then be provided that the sensor device 90 can likewise be pivoted about the pivoting axis 133, as is indicated by a pivoting direction 132. In particular, the sensor device 90 can also be designed to be pivotable about the optical axis 50. In this way, it becomes possible always to establish a state in which the direction 111 of incidence, the surface normal 126 and the optical axis 50 lie in the plane 128. In other words, the plane 128 can be arbitrarily rotated about the optical axis 50.

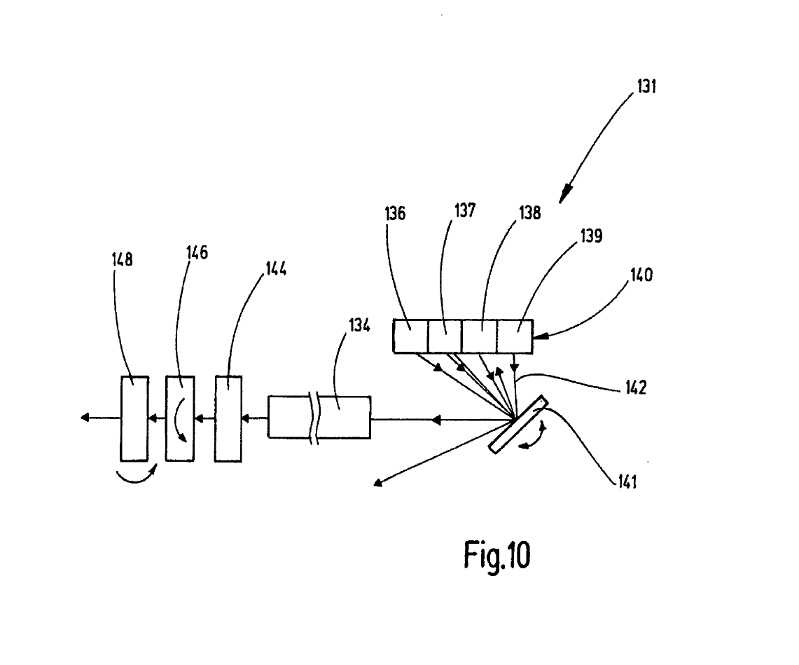

FIG. 10 illustrates one possible configuration of an illumination assembly 131. In particular, the illumination assembly 131 can have an optical fiber 134, into which light from one or a plurality of different light sources 136, 137, 138, 139 can selectively be coupled. The light sources 136 to 139 form an array 140 of light sources. In particular, the light sources 136 to 139 can each be embodied as an LED or OLED. In this case, each of the light sources 136 to 139 can emit light with a different wavelength range. The wavelength ranges can lie both in a spectrum visible to the human eye and also, for example, in the near infrared or infrared spectrum. By means of an MEMS scanner or any other pivotable reflection element, the light emitted by one of the light sources 136 to 139, in the case illustrated the light from the light source 142, can selectively be coupled into the optical fiber 134. This allows each of the light sources 136 to 139 to be left continuously switched on. Since some types of light sources are sensitive toward being switched on and off too frequently, a material-conserving configuration can thus be set up. Furthermore, the wavelengths can be changed rapidly by the pivoting of the reflection element 141. In particular, there is no elapsing of an unnecessary measurement time between switching on and switching off light sources 136 to 139 or a time duration for waiting until a light source 136 to 139 reaches its full light intensity.

Moreover, an illumination assembly 131 or the illumination device 104 can furthermore have a polarization element 144 that polarizes the incident light. Moreover, a λ/2 element can be provided, which is configured in a rotatable fashion. The polarization direction can then be set as desired with said element. Finally, an optics 148 can also be provided, which can be designed with pivotable elements. The optics 148 can serve for beam shaping, in particular to a line focus, and for radiating the light onto the measurement object 12 at a desired triangulation angle.

The arrangement of the elements 144 to 148 should in this case be understood to be merely by way of example. A different order can also be chosen or else for example one or more of the elements 144 to 148 can already be arranged in the beam path upstream of the optical fiber 134.

In order that elements of a measurement object 12 that are oriented both along the X-axis 19 and along the Y-axis 23 of the coordinate measuring machine 100 can be detected with relatively high resolution, it can be provided, in particular, that the direction 111 of incidence and the surface normal 126 together with the optical axis 50 are arranged in a plane 152 that forms an angle 151 of 45° with the X-axis 19 and likewise forms an angle 150 of 45° with the Y-axis 23. In this way, structures oriented both along the X-axis 19 and along the Y-axis 23 can be detected with relatively good resolution.

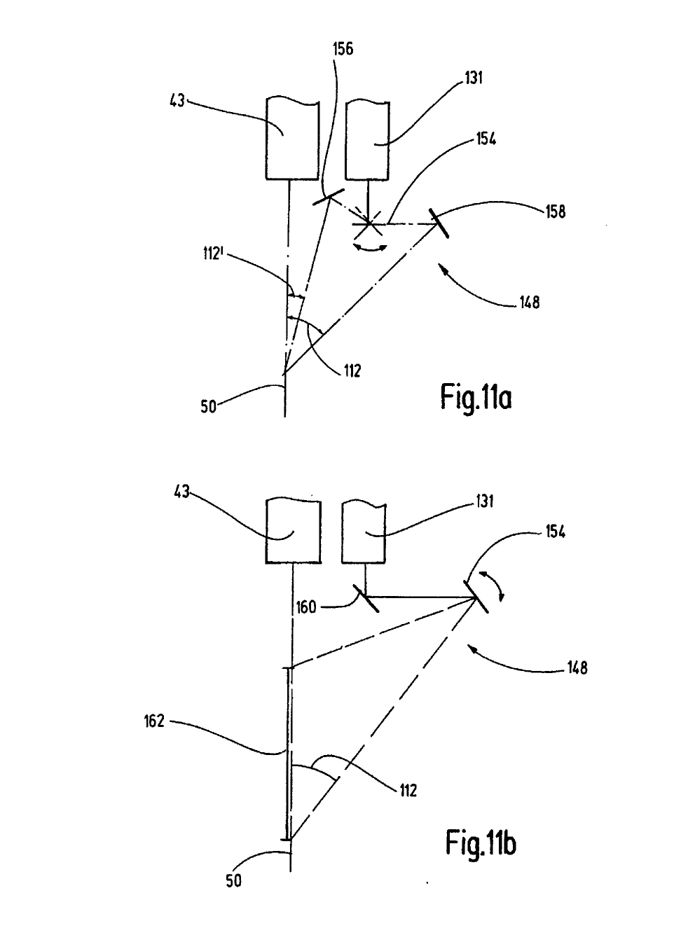

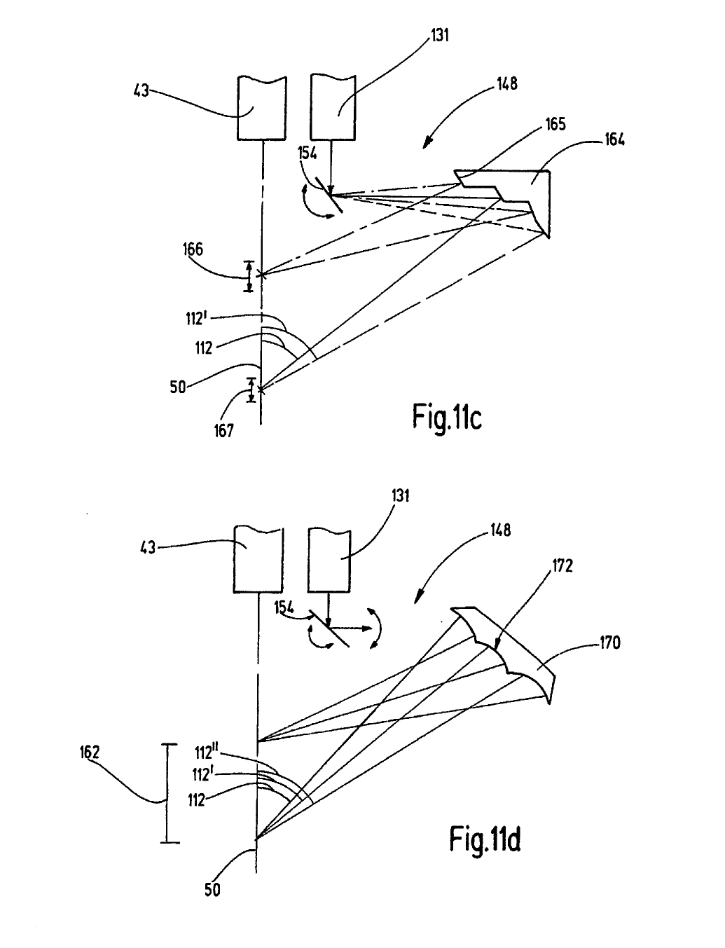

FIGS. 11a to 11d show different embodiments for the use of a microscanner 154 in the optics 148. In particular, the beam of rays from the illumination assembly 131 can already be shaped to form a line; a deflection element can also bring about parts of the beam shaping. By means of the pivotable or rotatable microscanner 154 it is then possible to determine a triangulation angle 112 and a location at which the beam of rays intersects the optical axis 50, that is to say it is possible to set the operating distance of the apparatus 10.

Thus, by way of example, by means of the arrangement illustrated in FIG. 11a, selectively a first deflection element 156 or a second deflection element 158 can be driven by means of the microscanner 154. Of course, even further deflection elements can additionally be arranged. The deflection elements can be optical elements, having plane, cylindrical or spherical surfaces. Aspherical surface or freeform surfaces are also possible. In this way it becomes possible, for example, to illuminate a specific operating distance with different triangulation angles 112.

By means of the arrangement illustrated in FIG. 11 b it becomes possible, for example, to use a range 162 of operating distances, a different triangulation angle 112 arising for each operating distance within the range 162. A larger operating distance then means a smaller triangulation angle 112, such that an achievable resolution also becomes smaller. A deflection element 160 can be provided for space reasons, under certain circumstances, but it is not absolutely necessary.

A deflection element 164 having a plurality of stepped surfaces 165, for instance, is provided in the arrangement illustrated in FIG. 11c. Such a deflection element 164 can be embodied in an integral fashion or can be composed of a plurality of individual elements. The arrangement illustrated makes it possible to illuminate different operating distances with different triangulation angles in each case. The operating distances can be divided here into a plurality of adjusting ranges 166, 167, but the adjusting ranges 166, 167 can also overlap.

Finally, the arrangement illustrated in FIG. 11d makes it possible to illuminate every point on the optical axis 50 in the range 162 in a plurality of triangulation angles 112, 112′, 112″. A deflection element 170 having a plurality of curved surfaces 172 is provided for this purpose. The deflection element 170, too, can be embodied in an integral fashion or can be composed of a plurality of individual elements.

By means of the exemplary arrangements in FIGS. 11a to 11d, the measurement object 12 can then also be scanned with the line even in the case of fixed setting of the optics 148 and/or machine position. Moreover, it becomes possible to use a light source with different triangulation angles for an operating distance. This then also makes possible, if appropriate, an increase in the measurement resolution by subpixeling and recording of scans with different line inclinations, in which case, however, consideration should then be given to the quality of the depth of field under the Scheimpflug condition set, for the respective magnification. In this regard, small variation of the operating distance could also be employed, however, in order to compensate for a displacement of the point of intersection of the optical axis of the zoom and the illumination direction. The deflection element is needed to bring about variations of the triangulation angle 112 for an operating distance or to vary the operating distance and the triangulation angle 112 jointly or independently of one another. With a continuously shaped mirror, it is then possible to carry out a depth scan with the zoom of the objective 43 and to vary triangulation angles in parallel therewith according to the Scheimpflug condition with fixed or else variable inclination of the sensor device. It goes without saying that the deflection element can also perform at least part of the optical function of collimation and line shaping optics.

What is claimed is:

1. An apparatus for inspecting a measurement object, comprising a workpiece support for receiving the measurement object and a measuring head carrying an optical sensor, wherein the measuring head and the workpiece support are movable relative to one another, wherein the optical sensor has an objective, wherein the objective has a light entrance opening and a light exit opening, wherein the objective furthermore has a diaphragm and a multitude of lens-element groups which are arranged in the objective between the light entrance opening and the light exit opening one behind another along a longitudinal axis of the objective, wherein at least two lens-element groups are displaceable parallel to the longitudinal axis, wherein the apparatus furthermore has an illumination device for at least partly illuminating the measurement object at at least one triangulation angle relative to the longitudinal axis, wherein the apparatus furthermore has a sensor device for detecting radiation from the illumination device that is incident on the sensor device through the objective, and wherein the sensor device is arranged in an inclined manner relative to the incident radiation.

2. The apparatus as claimed in claim 1, wherein the apparatus furthermore has a tilting device coupled to the sensor device and serving for tilting the sensor device relative to the incident radiation.

3. The apparatus as claimed in claim 1, wherein the illumination device is designed in such a way that different triangulation angles are selectable.

4. The apparatus as claimed in claim 1, wherein a direction of incidence of the radiation from the illumination device on the measurement object, a normal to a sensor plane of the sensor device and an optical axis of the objective lie in one plane.

5. The apparatus as claimed in claim 1, wherein the illumination device is designed such that the direction of incidence of the radiation from the illumination device about a pivoting axis, running parallel to the longitudinal axis, is selectable in steps or in a continuously variable manner.

6. The apparatus as claimed in claim 1, wherein the sensor device is pivotable about a pivoting axis running parallel to the longitudinal axis.

7. The apparatus as claimed in claim 1, wherein the illumination device has a plurality of illumination assemblies, wherein each illumination assembly is designed for projecting a line onto the measurement object.

8. The apparatus as claimed in claim 1, wherein the illumination device is pivotable about a pivoting axis running parallel to the longitudinal axis.

9. The apparatus as claimed in claim 3, wherein, for setting the triangulation angle and/or the direction of incidence of the radiation, at least one microscanner is arranged for deflecting the radiation.

10. The apparatus as claimed in claim 1, wherein the illumination device projects the radiation onto the measurement object in a punctiform manner, or wherein the illumination device projects the radiation onto the measurement object in a linear manner by means of an illumination imaging optics.

11. The apparatus as claimed in claim 1, wherein the illumination device has at least one light source, and wherein the light source is a laser or an LED.

12. The apparatus as claimed in claim 1, wherein the radiation which at least partly illuminates the measurement object is polarized.

13. The apparatus as claimed in claim 12, wherein the light emitted by a light source of the illumination device is polarized, or wherein the illumination device has a polarization element.

14. The apparatus as claimed in claim 12, wherein the illumination device has a λ/2 element for aligning the polarization direction.

15. The apparatus as claimed in claim 1, wherein the illumination device has a plurality of light sources, wherein the light sources emit light in different wavelength ranges or with different wavelengths.

16. The apparatus as claimed in claim 15, wherein each light source is an LED, and wherein the illumination device has an optical fiber and a pivotable reflection element arranged in such a way that selective coupling of the light emitted by one of the light sources into the optical fiber is made possible by pivoting of the reflection element.

17. The apparatus as claimed in claim 1, wherein the apparatus furthermore has an autofocus illumination device for projecting a line grating onto the measurement object and a camera, which is designed to capture an image of the measurement object through the objective, and wherein a line grating reflected by the measurement object is evaluated by means of the sensor device.

18. The apparatus as claimed in claim 17, wherein the apparatus furthermore has an autofocus beam splitter for separating a beam path of the autofocus illumination device and a beam path to the sensor device, and wherein the apparatus furthermore has a coupling-in beam splitter for coupling in the beam path of the autofocus illumination device and the beam path to the sensor device to the longitudinal axis.

19. The apparatus as claimed in claim 1, wherein the apparatus furthermore has an autofocus tilting device for tilting an emission plane of the autofocus illumination device.

20. The apparatus as claimed in claim 1, wherein the sensor device has a two-dimensional sensor array.

21. The apparatus as claimed in claim 1, wherein the sensor device is an High Dynamic Range camera.

22. A coordinate measuring machine comprising an apparatus for inspecting a measurement object, comprising a workpiece support for receiving the measurement object and a measuring head carrying an optical sensor, wherein the measuring head and the workpiece support are movable relative to one another, wherein the optical sensor has an objective, wherein the objective has a light entrance opening and a light exit opening, wherein the objective furthermore has a diaphragm and a multitude of lens-element groups which are arranged in the objective between the light entrance opening and the light exit opening one behind another along a longitudinal axis of the objective, wherein at least two lens-element groups are displaceable parallel to the longitudinal axis, wherein the apparatus furthermore has an illumination device for at least partly illuminating the measurement object at at least one triangulation angle relative to the longitudinal axis, wherein the apparatus furthermore has a sensor device for detecting radiation from the illumination device that is incident on the sensor device through the objective, wherein the sensor device is arranged in an inclined manner relative to the incident radiation, wherein the longitudinal axis forms a Z-axis of a Cartesian coordinate system, wherein the measuring head and the workpiece support are movable relative to one another parallel to an X-axis and to a Y-axis, wherein the X-axis and the Y-axis are perpendicular to one another and span an X-Y plane to which the Z-axis forms a normal, and wherein the sensor device is arranged in such a way that a normal to a sensor plane of the sensor device runs in a central plane that forms an angle of 45° both with the X-axis and with the Y-axis.
